(19) United States
(12) Patent Application Publication
(10) Pub. No.: US 2003/0017854 A1
(43) Pub. Date: Jan. 23, 2003

(54) Wireless mobile computing telephone dialer for use with landline telephone systems

(76) Inventor: Asher Avitan, Granada Hills, CA (US)

Correspondence Address: Matthew F. Jodziewicz, Esq., 3447 Mandeville Canyon Road, Los Angeles, CA, 90049-1019, US

(21) Appl. No.: 09/814,992

(22) Filed: Mar. 21, 2001

(51) Int. Cl. H04M 1/00

(52) U.S. Cl. 455/564; 455/557; 455/74.1; 379/56.3

(57) ABSTRACT

A dialer apparatus that receives a telephone number from a wireless mobile computing device and dials the telephone number over a wire landline telephone system includes wireless transceiver circuitry capable of communicating data with the wireless mobile computing device, for receiving and storing telephone dialing data from the wireless mobile computing device representative of a telephone number to be dialed over the landline telephone system. Off-hook circuitry is connected to the landline telephone system and is responsive to an off-hook command signal, for generating an off-hook signal to the landline telephone system. Dial tone detection circuitry is connected to the landline telephone system and generates a dial tone detected signal whenever a dial tone is detected on the landline telephone system. DTMF generating circuitry is connected to the landline telephone system for receiving a telephone number signal and generating and sending landline telephone number dialing tones representative thereof on the landline telephone system. Processing circuitry, operating under a control program, that determines if said telephone dialing data received from said wireless mobile computing device has the format of a valid telephone number and, if so, generates an off-hook command signal, upon receiving said dial tone detected signal, generates a telephone number signal for the DTMF generating circuitry, corresponding to the stored telephone dialing data received from the wireless mobile computing device.

### BACKGROUND OF THE INVENTION

1. Field of the Invention

The present invention is in the field of wireless telephony and mobile computing devices and generally relates to peripherals interfacing with wireless mobile computing devices and with landline telephony systems. More particularly, it pertains to a device capable of receiving a telephone number stored in a mobile computing device and dialing the number over a landline telephone system for benefits and reasons being explained and expanded upon below.

2. Description of the Prior Art

Computing devices have evolved from the large multi-room tube filed behemoths of fifty years ago through small transistorized console size computers to desk-top personal computers to laptops to current hand-held wireless computing devices known as personal digital assistants, that are capable of fitting into the palm of your hand.

These Personal Digital Assistants (PDAs) act not only as hand-held computing devices for computational purposes, but also are used to contain information for calendaring appointments, business and personal contact information and even, most recently, shopping (m-Commerce). Many busy professionals consider PDAs essential because of their tremendous versatility PDAs in helping to organize their information and keep track of their busy schedules while on the go.

Nevertheless, while these palm sized personal digital assistants have more computing and processing power than most computing systems of as recent as 5 years ago, they are still limited in their applicability and usefulness if they remain isolated and cannot communicate and interact with the outside world.

Most recently these palm sized computing devices have been connected with the outside world using wireless technology that enables them with access to not only an entire host of peripherals, but to such systems as the Internet or World Wide Web and landline telephony. However, this wireless connection is still in its infancy and many of the data resources held in the PDAs remain unavailable for use without the user's manual intervention.

One such problem area is that while PDAs are touted as being useful for holding contact information and for busy business executives on the road, such as telephone contact numbers, there is no easy way to retrieve such information directly and use it to automatically dial a landline telephone without having the user retrieve the desired telephone number from the PDA and then manually dial it on the landline telephone system. This becomes not merely an annoyance, but an extremely difficult proposition fraught with error due to the large number of dialing card, access and area codes that have to be entered for many business calls made from a public telephone while on the road. Also, attempting to juggle the PDA in one hand to read the displayed numbers, hold a telephone handset in one hand, and dial using the other hand becomes quite difficult for those having only two hands!

It is difficult for a user of such modem time savers, such as these mobile computing devices, to understand that all of the convenience and timesavings is lost, as well as errors introduced, by requiring that telephone numbers be manually entered and dialed whenever a call is to be made.

There is no known current solution to this bottleneck problem.

Therefore, it can be appreciated that in the modern world where efficiency and ease of use are becoming of paramount importance for the mobile businessman and even private individual on the go, there exists a continuing need for a new and improved apparatus and method for providing an automatic means to dial accurately telephone numbers stored in PDAs over landline telephone systems without having to have the user manually dial the desired numbers. Such a device must be easy to use, adaptable to the wide range of potential telephone numbers, durable, and overcome the limitations of the prior art as to the deficiencies noted above as well as to other aspects of the prior art as is better described below.

### OBJECTS AND SUMMARY OF THE INVENTION

In view of the foregoing disadvantages inherent in the known methods now present in the prior art, the present invention provides a dialer device that receives a telephone number from a wireless mobile computing device, such as a PDA, and automatically dials the telephone number over a wire landline telephone system. A preferred embodiment of the present invention includes wireless transceiver circuitry that is capable of communicating data with the wireless mobile computing device, for receiving and storing telephone dialing data from the wireless mobile computing device. Off-hook circuitry is connected to the landline telephone system and is responsive to an off-hook command signal, to generate an off-hook signal to the landline telephone system. Time delay circuitry can be used to generate a dial tone detected signal following a timed interval after generation of the off-hook signal. In the alternative, dial tone detection circuitry can be connected to the landline telephone system and generates a dial tone detected signal whenever a dial tone is detected on the landline telephone system. DTMF or pulse generating circuitry is connected to the landline telephone system so that it can receive a telephone number signal and generate and send landline telephone number dialing tones representative of the telephone number on the landline telephone system. Processing circuitry, operating under a control program, determines if the received telephone dialing information has the format of a valid telephone number and, if so, generates an off-hook command signal, once it receives the dial tone detected signal. The processing circuitry also generates a telephone number signal for the DTMF generating circuitry that corresponds to the stored telephone dialing data received from the wireless mobile computing device.

There has thus been defined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components or steps set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a landline telephone dialing device that interfaces in a wireless manner with a mobile computing device for automatically receiving and dialing a telephone number selected from those stored in the mobile computing device.

It is another object of the present invention to provide a landline telephone dialing device that interfaces in a wireless manner with a mobile computing device for automatically receiving and dialing a telephone number selected from those stored in the mobile computing device that may be easily and efficiently manufactured and marketed.

It is a further object of the present invention to provide a landline telephone dialing device that interfaces in a wireless manner with a mobile computing device for automatically receiving and dialing a telephone number selected from those stored in the mobile computing device that is of a durable and reliable operation.

An even further object of the present invention to provide a landline telephone dialing device that interfaces in a wireless manner with a mobile computing device for automatically receiving and dialing a telephone number selected from those stored in the mobile computing device whose design, method and structure are simplified for the users, while security and accuracy of dialing is increased.

Lastly, it is an object of the present invention to provide a landline telephone dialing device that interfaces in a wireless manner with a mobile computing device for automatically receiving and dialing a telephone number selected from those stored in the mobile computing device that is transparent and easy to use for users.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is an illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is an idealized block schematic of circuitry illustrating a dialer embodying the present invention;

FIG. 2 is a flowchart illustrating the logic and operational procedures of how a user would use a dialer embodying the present invention;

FIG. 3 is a flowchart illustrating the logic and operational procedures of how a dialer embodying the present invention would work to process a telephone call;

FIG. 4 illustrates, in idealized form, how a dialer embodying the present invention would be connected to a landline telephone system; and, FIG. 5 illustrates, in idealized form, how a dialer embodying the present invention could be connected to a landline telephone system using a cordless handset.

Similar reference characters refer to similar parts throughout the several views of the drawings.

### DESCRIPTION OF THE PREFERRED EMBODIMENT

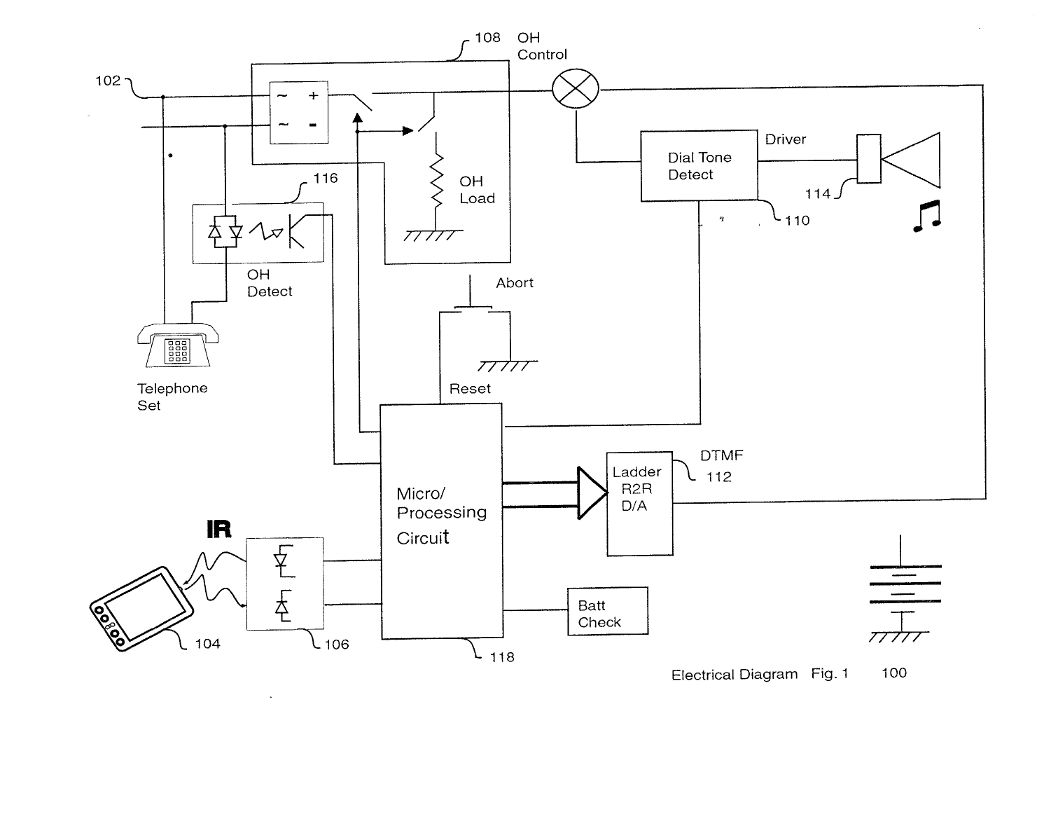

With reference now being made to structure and method appearing in the drawings in the Figures, a dialer device that receives a telephone number from a wireless mobile computing device, such as a PDA, and automatically dials the telephone number over a wire landline telephone system that embodies the principles and concepts of the present invention and generally designated by the reference numeral 100 in FIG. 1 will now be described.

A dialer apparatus 100 is preferably used with a telephone handset that is connected to a wire landline telephone system 102, and a wireless mobile computing device 104 that has telephone numbers stored as data therein and that is capable of communicating such stored data with outside devices using a wireless medium.

Most PDAs and other mobile computing devices incorporate Infra-red transceivers utilizing a known standard of data communications or data transfer such as that of the Infra-Red Data Association's IrDA protocol standard. While this is the most prevalent protocol standard in use today, it is also envisioned that the present invention will work with any such data protocol as is methods and processes are not limited to any one such data transfer protocol.

Dialer apparatus 100 is generally useful for directly receiving stored data from the wireless mobile computing device or PDA using such a data transfer protocol as IrDA that is representative of a telephone number that the user has selected for dialing and automatically dialing the telephone number over the wire landline telephone system.

Dialer 100 preferably includes wireless transceiver circuitry 106 that is capable of communicating data using the known protocol system with the wireless mobile computing device 104. Transceiver circuitry 106 utilizes the known data transfer protocol to establish a data transfer link with device 104 and then receive and store telephone dialing data from the wireless mobile computing device 104 that is representative of a telephone number selected by a user to be dialed over the landline telephone system 102.

One of the most common current communications methods is the use of optical transceivers using infrared frequencies to communication between PDAs and the outside world under the IrDA data transfer protocol. Accordingly, it is preferred that transceiver circuitry 106 would be an IR transceiver circuit that uses such light sensitive elements such as a pair of light sensitive and light emitting diodes. Other circuitry would include transceivers operating at radio frequency or any other data transceiver that is compatible to that utilized by the PDA for its data transmission with outside peripherals.

Another alternative embodiment of the present invention would be to utilize wireless receiver circuitry as opposed to transceiver circuitry for additional simplicity in design and use. As such, the dialer would be similar to a remote control device as is used for controlling televisions and videocassette recorders. In this embodiment of the invention, there is no need for complicated handshake protocols between the dialer and the wireless mobile computing device. The wireless mobile computing device need only transmit the telephone dialing information blindly for any and all capable of receiving the information.

It is preferred that transceiver circuitry 106 also generate a wake-up signal whenever the telephone dialing data is received for power consumption purposes as is better described below in controlling the processing circuitry of the dialer.

Off-hook circuitry 108 is connected to the landline telephone system 102 as by a standard RJ-11 jack and acts, in response to an off-hook command signal, to generate an off-hook signal to the landline telephone system 102. Generally, this off-hook signal is used by landline telephone systems to indicate that a user has picked up a handset and is ready to use the landline system to either receive or dial a telephone call.

Dial tone detection circuitry 110 is connected to the landline telephone system 102 and generates a dial tone detected signal whenever a dial tone is detected on the landline telephone system 102. Landline telephone systems generally place a dial tone signal on the telephone lines in response to receiving an off-hook signal to assure the user that the landline telephone lines are active and ready to receive dialing information.

DTMF generating circuitry 112 is connected to landline telephone system 102 for receiving a telephone number signal and generating and sending landline telephone number dialing tones that are representative of the telephone number received from PDA 104 on the landline telephone system 102.

DTMF generating circuitry 112 also generates an end of dialing signal upon completion of sending the landline telephone number dialing tones on landline telephone system 102.

DTMF generating circuitry 112 can also be incorporated directly in the circuitry of processing circuitry 118, as many currently available processing chipsets include such capability for DTMF tone generation.

Likewise, the invention also includes having pulse generating circuitry used to generate landline telephone system signals, as some older landline telephone systems still rely on the pulse signal method of transmitting telephone dialing information and not the newer DTMF tone method. Both methods of transmitting telephone dialing data are included in the invention.

It is also preferred that dialer 110 include an alarm or line monitor circuit 114 that is responsive to the end of dialing signal generated by DTMF circuitry 112 to alert a user that dialing of the telephone number is complete and that they can now pick up the handset. This notification function can be performed by a visual or an audio means, such as a buzzer that sounds upon dialing completion or a speaker that allows the user to hear the various dial tones and ringing signals on the landline telephone system so that he knows when to pick up the headset.

User or local off-hook detection circuitry 116 is connected to landline telephone system 102 for generating a handset off-hook signal whenever a user lifts the local handset. This is useful, among other things, for power conservation control of the dialer as is better described below.

Processing circuitry 118, such as a microprocessor or CPU, is operatively connected to each of the above circuits for receiving input signals therefrom and for controlling their actions by generating appropriate control signals as better described in the following. Processing circuitry 118 preferably operates under a stored control program, that determines if the telephone dialing data received from wireless mobile computing device 104 has the format of a valid telephone number and, if so, generates an off-hook command signal for use by user off hook circuitry 116. Upon receiving the dial tone detected signal from dial tone detection circuitry 110, processing circuitry 118 generates a telephone number signal corresponding to the stored telephone dialing data received from wireless mobile computing device 104 for use by DTMF generating circuitry 112 to complete the dialing process on the landline.

While this is sufficient to dial automatically the telephone number selected from those stored in the PDA 104, it is preferred that additional circuitry be added to make the process easier and more efficient without limiting the present invention.

Alternate embodiments of the present invention would include circuitry designed for controlling the power consumption of dialer 100 so that it may be powered from batteries as well as from a direct power source. In order to accomplish this, one preferred method is to have wireless transceiver circuitry 106 further generate a wake-up signal whenever the telephone dialing information is received, and have processing circuitry 118 further operating under its control program that, in response to the wake-up signal processing circuit 118 goes into a power-up mode of operating, and, upon receiving the handset off-hook signal from local off-hook detection circuitry 116, goes into a power saving power-down mode of operating until once again receiving a wake-up signal. With this two mode, power up and power down, operating states, dialer 100 is more efficient in using energy only when a call is being initiated and powering down once the call is made, so as to enable it to use both batteries as well as electrical mains for its power.

Alternate embodiments of the present invention include having the dialer generate an audible signal after the telephone dialing information has been received by the dialer, and rely on the user to pick up the handset to generate the off hook signal to commence the dialing procedure over the landline telephone system.

In this alternate embodiment, the user aims the wireless mobile computing device and has it send the telephone dialing data. The dialer device of the present invention captures the data. The dialer device then waits until it detects the off hook signal generated by the user picking up the handset of the landline telephone system. Once the off hook signal is detected, the dialer device continues, as above, to generate the dialing signals on the landline telephone system, and complete the call for the user.

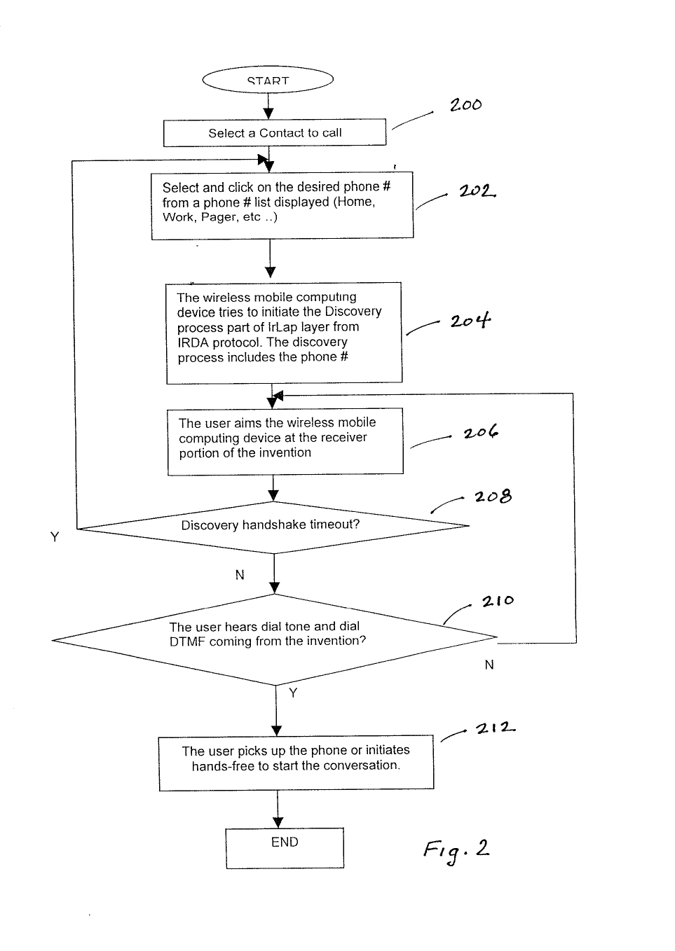

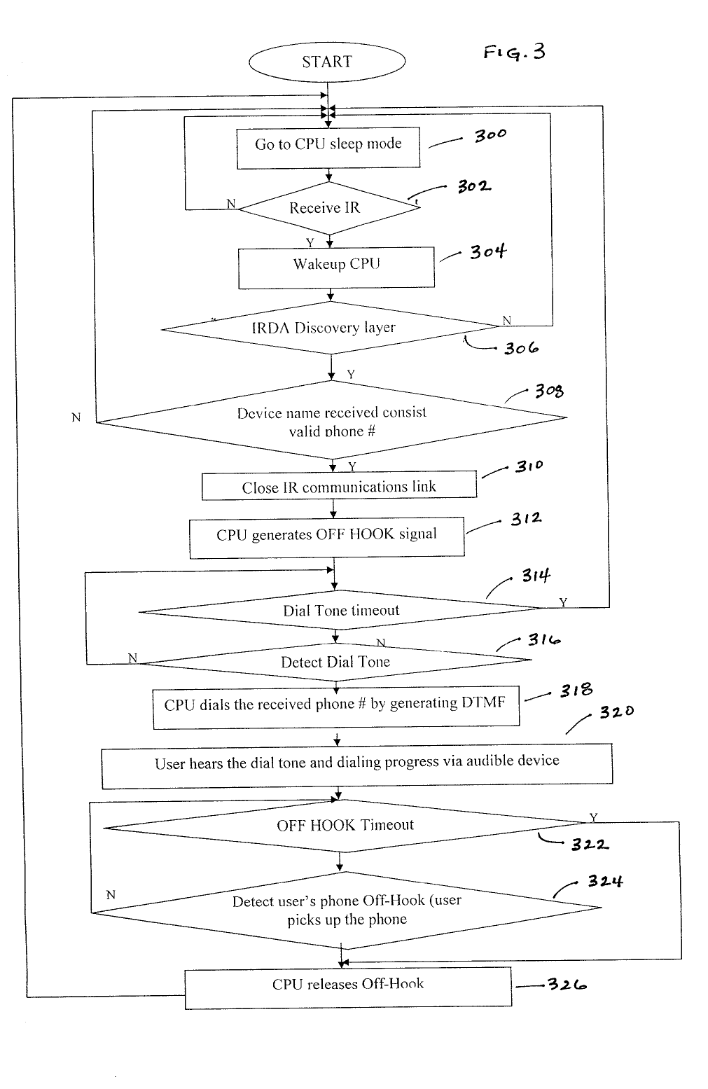

Operation of the dialer 100 in connection with the PDA 104 is illustrated in FIGS. 2 and 3 in flowchart format.

With reference being made to FIG. 2, a user first selects 200 a contact stored in his mobile computing device.

While user display interfaces differ among the various types of mobile computing devices currently available, most will display the stored contact information and allow a user to select and click 202 on the desired telephone number from a displayed telephone listing (home, work, pager, facsimile, etc.) for each contact.

The mobile computing device will then utilize its data transfer protocol and transceiver circuitry to transmit the selected telephone number 204.

Since mobile computing devices use a wireless transfer method such as an IR transceiver, the user then need only aim or direct the mobile computing device in the general direction of the transceiver circuitry of the dialer device embodying the present invention to start the data transfer process from the mobile computing device to the dialer 206.

Both the mobile computing device and dialer then engage in the data protocol conventions necessary to transfer, receive and confirm receipt of the data between the units 208.

Once the dialer of the present invention successfully receives the data and the call is placed on the landline telephone system, the dialer circuitry alerts the user as to the completion of the call by audibly generating a dial tone and DTMF signals 210.

Once the user hears the completion of the dial tone and DTMF signals, he is free to pick up the landline handset and wait for the dialed party to answer the call 212.

FIG. 3 shows in detail the internal operational processes of a dialer that embodies the present invention.

In order to conserve power so as to allow the dialer to utilize battery power, the dialer preferably begins its operation in a “sleep mode” that conserves power 300.

The PDA transmits its information using the common data transmission protocol, such as IrDA for Infrared data transmissions. This transmitted signal is received by the corresponding transceiver circuitry in the dialer 302 and a wake-up signal is generated 304 to power-up the processing circuitry of the dialer. The PDA and dialer then continue to process through the various protocol layers necessary to achieve a successful data transmission in accord with the chosen protocol structure 306.

The processing circuitry of the dialer then validates the received data 308 to determine if it is a valid telephone number before proceeding further. Once the data is validated as having the appropriate format for a valid telephone number, the communications link is closed 310 and the processing circuitry generates an off-hook signal 312.

The off-hook signal is detected by the off-hook detection circuitry of the dialer within a specified time 314 to insure that the dialer is rendered inoperative due to the landline telephone system failing to be active and generate a dial tone 316.

Once the landline dial tone is detected, the processing circuitry uses the DTMF tone generating circuitry of the dialer to dial the received telephone number by generating DTMF dialing tones and placing them on the landline telephone system connection to the dialer 318.

Once the telephone number is dialed, the dialer generates an audible signal to alert the user that the dialing is concluded and that the handset is available for pick up 320.

To conserve energy and avoid lockouts of the dialer, the user is given a time interval in which to pick up the handset 322. Once the user's taking the handset off-hook is detected 324, the processing circuitry of the dialer releases the off-hook status of the landline connection 326, and returns to the power down state 300 to await instructions to dial another call.

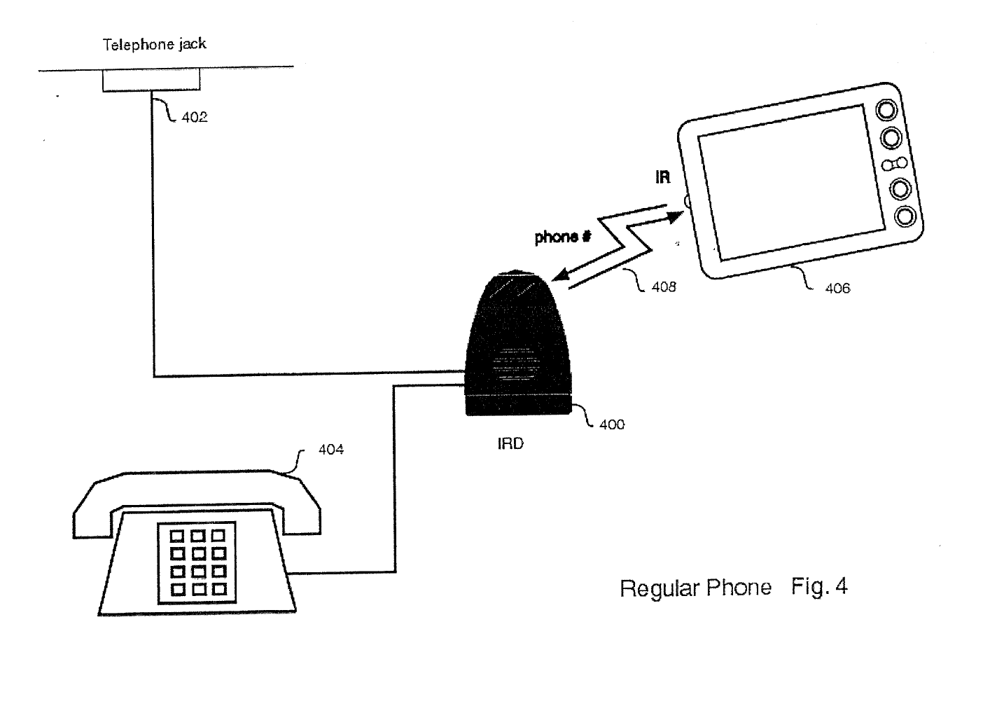

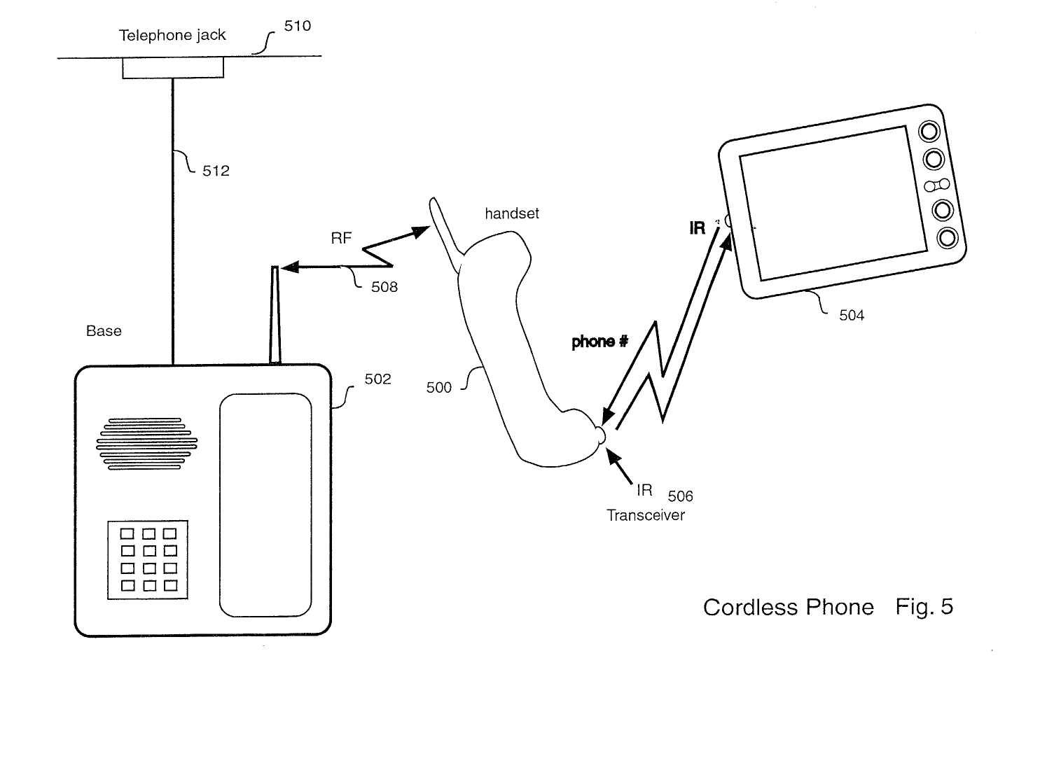

FIG. 4 illustrates in an idealized form how a dialer 400 embodying the present invention is connected to a landline telephone system 402 and a local handset 404. Dialer 400 receives dialing information from a PDA or mobile computing device 406 via a wireless data communication connection such as an Infrared transceiver combination located in both dialer 400 and PDA 406.

For ease of connection to the landline telephone system 402, dialer 400 may utilize a pair of RJ-11 or similar telephone jacks commonly found in landline telephone system to connect to both handset 404 and landline telephone system 402. With this arrangement, a user can merely disconnect a handset from the telephone wall socket connector and connect the handset directly to the dialer. Similarly, a telephone wire can be connected between the now empty telephone wall socket and the dialer's remaining telephone jack port to provide a connection allowing the dialing circuitry to operate to dial the desired number and allow the user to merely pick up the handset once the number has been dialed.

Finally, FIG. 5 illustrates that dialer circuitry described above as embodying the present invention can be incorporated into a cordless handset either in the handset portion itself or in the base portion of the handset (not illustrated).

Specifically, with reference to FIG. 5, dialer circuitry is shown incorporated into the handset portion 500 of a cordless telephone having a base member 502. Dialer circuitry receives dialing information from a PDA or mobile computing device 504 via a wireless data communication connection such as an Infrared transceiver combination 506 located in both handset 500 and PDA 504. Once the dialing information is received, it is transmitted to the base station 502 via a standard radio frequency link 508. Base station 502 is connected to landline telephone system 510 using a standard modular RJ-11 wire connection 512. Dialer circuitry can be placed in either handset portion 500 or base station portion 502 of the cordless telephone as may be deemed convenient for the operating environment of the device.

The present invention is also found embodied in a method of dialing a telephone number stored in a wireless mobile computing device having telephone numbers stored as data therein and capable of communicating data with outside devices using a wireless medium, over a wire landline telephone system using a telephone handset connected to the wire landline telephone system.

One preferred method comprises the steps of:

Receiving and storing telephone dialing data from the wireless mobile computing device representative of a telephone number to be dialed over the landline telephone system using wireless transceiver circuitry capable of communicating data with the wireless mobile computing device;

Determining if said telephone dialing data received has the format of a valid telephone number and, if so, generating an off-hook command signal, and then upon receiving the dial tone detected signal, generating a telephone number signal corresponding to the stored telephone dialing data received from the wireless mobile computing device;

Generating an off-hook signal to the landline telephone system in response to an off-hook command signal;

Monitoring the landline telephone system, and generating a dial tone detected signal whenever a dial tone is detected on the landline telephone system; and,

Receiving a telephone number signal and generating and sending landline telephone number dialing tones representative thereof on the landline telephone system;

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A dialer apparatus for use with a telephone handset, connected to a wire landline telephone system, and a wireless mobile computing device having telephone numbers stored as data therein and capable of communicating data with outside devices using a wireless medium, said dialer apparatus useful for receiving data representative of a telephone number from the wireless mobile computing device and dialing the telephone number over the wire landline telephone system, said dialer apparatus comprising:
Wireless transceiver circuitry capable of communicating data with the wireless mobile computing device, for receiving and storing telephone dialing data from the wireless mobile computing device representative of a telephone number to be dialed over the landline telephone system and for generating a wake-up signal whenever the telephone dialing data is received;
Off-hook circuitry, connected to the landline telephone system, responsive to an off-hook command signal, for generating an off-hook signal to the landline telephone system;
Dial tone detection circuitry, connected to the landline telephone system, for generating a dial tone detected signal whenever a dial tone is detected on the landline telephone system;
DTMF generating circuitry, connected to the landline telephone system, for receiving a telephone number signal and generating and sending landline telephone number dialing tones representative thereof on the landline telephone system, said DTMF generating circuitry also generating an end of dialing signal upon completion of sending said landline telephone number dialing tones on said landline telephone system;
Line monitor circuitry, responsive to said end of dialing signal, to alert a user that dialing is complete and to pick up the handset;
User off-hook detection circuitry, connected to the landline telephone system, for generating a handset off-hook signal whenever a user lifts the handset; and,
Processing circuitry, operating under a control program, that, in response to said wake-up signal, goes into a power-up mode and determines if said telephone dialing data received from said wireless mobile computing device has the format of a valid telephone number and, if so, generates an off-hook command signal, upon receiving said dial tone detected signal, generates a telephone number signal corresponding to the stored telephone dialing data received from said wireless mobile computing device, and, upon receiving said handset off-hook signal, goes into a power saving power-down mode of operation until receiving said wake-up signal.

2. A dialer apparatus as in claim 1 wherein said wireless transceiver circuitry further comprises an optical transceiver.

3. A dialer apparatus as in claim 2 wherein said optical transceiver comprises an Infrared transceiver.

4. A dialer apparatus as in claim 1 wherein said wireless transceiver circuitry further comprises a radio frequency transceiver.

5. A dialer apparatus for use with a telephone handset, connected to a wire landline telephone system, and a wireless mobile computing device having telephone numbers stored as data therein and capable of communicating data using a known protocol with outside devices using an Infra-Red transceiver, said dialer apparatus useful for receiving data representative of a telephone number from the wireless mobile computing device and dialing the telephone number over the wire landline telephone system, said dialer apparatus comprising:
Infra-Red transceiver circuitry capable of communicating data with the infra-red transceiver of the wireless mobile computing device, for receiving and storing telephone dialing data from the wireless mobile computing device representative of a telephone number to be dialed over the landline telephone system and for generating a wake-up signal whenever the telephone dialing data is received;
Off-hook circuitry, connected to the landline telephone system, responsive to an off-hook command signal, for generating an off-hook signal to the landline telephone system;
Dial tone detection circuitry, connected to the landline telephone system, for generating a dial tone detected signal whenever a dial tone is detected on the landline telephone system;
DTMF generating circuitry, connected to the landline telephone system, for receiving a telephone number signal and generating and sending landline telephone number dialing tones representative thereof on the landline telephone system, said DTMF generating circuitry also generating an end of dialing signal upon completion of sending said landline telephone number dialing tones on said landline telephone system;
Line monitor circuitry, responsive to said end of dialing signal, to alert a user that dialing is complete and to pick up the handset;
User off-hook detection circuitry, connected to the landline telephone system, for generating a handset off-hook signal whenever a user lifts the handset; and,
Processing circuitry, operating under a control program, that, in response to said wake-up signal, goes into a power-up mode and determines if said telephone dialing data received from said wireless mobile computing device has the format of a valid telephone number and, if so, generates an off-hook command signal, upon receiving said dial tone detected signal, generates a telephone number signal corresponding to the stored telephone dialing data received from said wireless mobile computing device, and, upon receiving said handset off-hook signal, goes into a power saving power-down mode of operation until receiving said wake-up signal.

6. A dialer apparatus for use with a telephone handset, connected to a wire landline telephone system, and a wireless mobile computing device having telephone numbers stored as data therein and capable of communicating data with outside devices using a wireless medium, said dialer apparatus useful for receiving data representative of a telephone number from the wireless mobile computing device and dialing the telephone number over the wire landline telephone system, said dialer apparatus comprising:
Wireless transceiver circuitry capable of communicating data with the wireless mobile computing device, for receiving and storing telephone dialing data from the wireless mobile computing device representative of a telephone number to be dialed over the landline telephone system;
Off-hook circuitry, connected to the landline telephone system, responsive to an off-hook command signal, for generating an off-hook signal to the landline telephone system;
Dial tone detection circuitry, connected to the landline telephone system, for generating a dial tone detected signal whenever a dial tone is detected on the landline telephone system;
DTMF generating circuitry, connected to the landline telephone system, for receiving a telephone number signal and generating and sending landline telephone number dialing tones representative thereof on the landline telephone system; and,
Processing circuitry, operating under a control program, that determines if said telephone dialing data received from said wireless mobile computing device has the format of a valid telephone number and, if so, generates an off-hook command signal, upon receiving said dial tone detected signal, generates a telephone number signal for said DTMF generating circuitry, corresponding to the stored telephone dialing data received from said wireless mobile computing device.

7. A dialer apparatus as in claim 6 wherein said DTMF generating circuitry further generating an end of dialing signal upon completion of sending said landline telephone number dialing tones on said landline telephone system; and further comprising alarm circuitry, responsive to said end of dialing signal, to alert a user that dialing is complete and to pick up the handset.

8. A dialer apparatus as in claim 6 further comprising:
User off-hook detection circuitry, connected to the landline telephone system, for generating a handset off-hook signal whenever a user lifts the handset;
wherein said wireless transceiver circuitry further generates a wake-up signal whenever the telephone dialing information is received, and said processing circuitry further operates under said control program that, in response to said wake-up signal goes into a power-up mode of operating, and, upon receiving said handset off-hook signal, goes into a power saving power-down mode of operating until receiving said wake-up signal.

9. A dialer apparatus as in claim 6 wherein said wireless transceiver circuitry further comprises an optical transceiver.

10. A dialer apparatus as in claim 9 wherein said optical transceiver comprises an Infrared transceiver.

11. A dialer apparatus as in claim 6 wherein said wireless transceiver circuitry further comprises a radio frequency transceiver.

12. A method of dialing a telephone number stored in a wireless mobile computing device having telephone numbers stored as data therein and capable of communicating data with outside devices using a wireless medium, over a wire landline telephone system using a telephone handset connected to the wire landline telephone system comprising the steps of:
Receiving and storing telephone dialing data from the wireless mobile computing device representative of a telephone number to be dialed over the landline telephone system using wireless transceiver circuitry capable of communicating data with the wireless mobile computing device;
Determining if said telephone dialing data received has the format of a valid telephone number and, if so, generating an off-hook command signal, and then upon receiving said dial tone detected signal, generating a telephone number signal corresponding to the stored telephone dialing data received from said wireless mobile computing device;
Generating an off-hook signal to the landline telephone system in response to an off-hook command signal;
Monitoring the landline telephone system, and generating a dial tone detected signal whenever a dial tone is detected on the landline telephone system; and,
Receiving a telephone number signal and generating and sending landline telephone number dialing tones representative thereof on the landline telephone system;

13. A dialer apparatus for use with a telephone handset, connected to a wire landline telephone system, and a wireless mobile computing device having telephone numbers stored as data therein and capable of communicating data with outside devices using a wireless medium, said dialer apparatus useful for receiving data representative of a telephone number from the wireless mobile computing device and dialing the telephone number over the wire landline telephone system, said dialer apparatus comprising:
Wireless transceiver circuitry capable of communicating data with the wireless mobile computing device, for receiving telephone dialing data from the wireless mobile computing device representative of a telephone number to be dialed over the landline telephone system; and,
Processing circuitry, connected to the landline telephone system, that upon receiving telephone dialing data from said wireless transceiver circuitry, generates an off-hook command signal and a telephone number signal corresponding to the stored telephone dialing data received from said wireless mobile computing device to the landline telephone system.

14. A dialer apparatus as in claim 13 further comprising
Dial tone detection circuitry, connected to the landline telephone system, for generating a dial tone detected signal whenever a dial tone is detected on the landline telephone system, said processing circuitry generating said off-hook command signal, upon receiving said dial tone detected signal.

15. A dialer apparatus as in claim 13 wherein said processing circuitry further comprises:
DTMF generating circuitry, connected to the landline telephone system, for receiving a telephone number signal and generating and sending landline telephone number dialing tones representative thereof on the landline telephone system.

16. A dialer apparatus as in claim 15 wherein said DTMF generating circuitry further generating an end of dialing signal upon completion of sending said landline telephone number dialing tones on the landline telephone system.

17. A dialer apparatus as in claim 13 wherein said processing circuitry further comprises:
pulse generating circuitry, connected to the landline telephone system, for receiving a telephone number signal and generating and sending landline telephone number dialing pulse signals representative thereof on the landline telephone system.

18. A dialer apparatus as in claim 17 wherein said pulse generating circuitry further generating an end of dialing signal upon completion of sending said landline telephone number dialing pulse signals on the landline telephone system.

19. A dialer apparatus as in claim 16 further comprising:
Line monitoring circuitry, responsive to said end of dialing signal, to alert a user that dialing is complete and to pick up the handset.

20. A dialer apparatus as in claim 18 further comprising:
Line monitoring circuitry, responsive to said end of dialing signal, to alert a user that dialing is complete and to pick up the handset.

21. A dialer apparatus as in claim 13 wherein said wireless transceiver circuitry further comprises an optical transceiver.

22. A dialer apparatus as in claim 21 wherein said optical transceiver comprises an Infrared transceiver.

23. A dialer apparatus as in claim 13 wherein said wireless transceiver circuitry further comprises a radio frequency transceiver.

24. A dialer apparatus as in claim 13 wherein said wireless transceiver circuitry stores said telephone dialing, data received from the wireless mobile computing device for later retrieval.

25. A dialer apparatus as in claim 13 wherein said wireless transceiver circuitry further generating a wake-up signal whenever the telephone dialing data is received, and said processing circuitry operating in response to said wake-up signal, goes into a power-up mode and, after generating said off-hook command signal and said telephone number signal corresponding to the stored telephone dialing data received from said wireless mobile computing device to the landline telephone system, goes into a power saving power-down mode of operation until once again receiving said wake-up signal.

26. A dialer apparatus for use with a telephone handset, connected to a wire landline telephone system, and a wireless mobile computing device having telephone numbers stored as data therein and capable of communicating data using a known protocol with outside devices using an Infra-Red transceiver, said dialer apparatus useful for receiving data representative of a telephone number from the wireless mobile computing device and dialing the telephone number over the wire landline telephone system, said dialer apparatus comprising:
Infra-Red transceiver circuitry capable of communicating data with the infra-red transceiver of the wireless mobile computing device, for receiving telephone dialing data from the wireless mobile computing device representative of a telephone number to be dialed over the landline telephone system; and,
Processing circuitry, connected to the landline telephone system, that upon receiving telephone dialing data from said wireless transceiver circuitry, generates a telephone number signal corresponding to the stored telephone dialing data received from said wireless mobile computing device to the landline telephone system.

27. A dialer apparatus as in claim 26 further comprising
Dial tone detection circuitry, connected to the landline telephone system, for generating a dial tone detected signal whenever a dial tone is detected on the landline telephone system, said processing circuitry generating an off-hook command signal, upon receiving said dial tone detected signal.

28. A dialer apparatus as in claim 26 wherein said processing circuitry further comprises:
DTMF generating circuitry, connected to the landline telephone system, for receiving a telephone number signal and generating and sending landline telephone number dialing tones representative thereof on the landline telephone system.

29. A dialer apparatus as in claim 28 wherein said DTMF generating circuitry further generating an end of dialing signal upon completion of sending said landline telephone number dialing tones on the landline telephone system.

30. A dialer apparatus as in claim 26 wherein said processing circuitry further comprises:
pulse generating circuitry, connected to the landline telephone system, for receiving a telephone number signal and generating and sending landline telephone number dialing pulse signals representative thereof on the landline telephone system.

31. A dialer apparatus as in claim 30 wherein said pulse generating circuitry further generating an end of dialing signal upon completion of sending said landline telephone number dialing pulse signals on the landline telephone system.

32. A dialer apparatus as in claim 29 further comprising:
Line monitoring circuitry, responsive to said end of dialing signal, to alert a user that dialing is complete and to pick up the handset.

33. A dialer apparatus as in claim 26 wherein said wireless transceiver circuitry stores said telephone dialing data received from the wireless mobile computing device for later retrieval.

34. A dialer apparatus as in claim 26 wherein said Infra-red transceiver circuitry further generating a wake-up signal whenever the telephone dialing data is received, and said processing circuitry operating in response to said wake-up signal, goes into a power-up mode and, after generating said off-hook command signal and said telephone number signal corresponding to the stored telephone dialing data received from said wireless mobile computing device to the landline telephone system, goes into a power saving power-down mode of operation until once again receiving said wake-up signal.

35. A method of dialing a telephone number stored in a wireless mobile computing device having telephone numbers stored as data therein and capable of communicating data with outside devices using a wireless medium, over a wire landline telephone system using a telephone handset connected to the wire landline telephone system comprising the steps of:
Receiving optically telephone dialing data from the wireless mobile computing device representative of a telephone number to be dialed over the landline telephone system using wireless transceiver circuitry capable of communicating data with the wireless mobile computing device;
Generating an off-hook command signal on the landline telephone system; and,
Generating a telephone number signal corresponding to the telephone dialing data received from said wireless mobile computing device on the landline telephone system.

36. The method of claim 35 further comprising the step of:
Determining if said telephone dialing data received from said wireless mobile computing device has the format of a valid telephone number.

37. A dialer apparatus for use with a telephone handset, connected to a wire landline telephone system, and a wireless mobile computing device having telephone numbers stored as data therein and capable of communicating data with outside devices using a wireless medium, said dialer apparatus useful for receiving data representative of a telephone number from the wireless mobile computing device and dialing the telephone number over the wire landline telephone system, said dialer apparatus comprising:
Wireless circuitry for receiving telephone dialing data from the wireless mobile computing device representative of a telephone number to be dialed over the landline telephone system; and,
Processing circuitry, connected to the landline telephone system, that upon receiving telephone dialing data from said wireless circuitry, and a telephone number signal corresponding to the stored telephone dialing data received from said wireless mobile computing device to the landline telephone system.

38. A dialer apparatus as in claim 37 further comprising
Dial tone detection circuitry, connected to the landline telephone system, for generating a dial tone detected signal whenever a dial tone is detected on the landline telephone system, said processing circuitry generating said off-hook command signal, upon receiving said dial tone detected signal.

39. A dialer apparatus as in claim 37 wherein said processing circuitry further comprises:
DTMF generating circuitry, connected to the landline telephone system, for receiving a telephone number signal and generating and sending landline telephone number dialing tones representative thereof on the landline telephone system.

40. A dialer apparatus as in claim 39 wherein said DTMF generating circuitry further generating an end of dialing signal upon completion of sending said landline telephone number dialing tones on the landline telephone system.

41. A dialer apparatus as in claim 37 wherein said processing circuitry further comprises:
pulse generating circuitry, connected to the landline telephone system, for receiving a telephone number signal and generating and sending landline telephone number dialing pulse signals representative thereof on the landline telephone system.

42. A dialer apparatus as in claim 41 wherein said pulse generating circuitry further generating an end of dialing signal upon completion of sending said landline telephone number dialing pulse signals on the landline telephone system.

43. A dialer apparatus as in claim 40 further comprising:
Line monitoring circuitry, responsive to said end of dialing signal, to alert a user that dialing is complete and to pick up the handset.

44. A dialer apparatus as in claim 37 wherein said processing circuitry only generates said off-hook signal if said telephone dialing data received from said wireless mobile computing device has the format of a valid landline telephone number.

45. A dialer apparatus as in claim 37 wherein said wireless circuitry further comprises an optical receiver.

46. A dialer apparatus as in claim 45 wherein said optical receiver comprises an Infrared receiver.

47. A dialer apparatus as in claim 37 wherein said wireless circuitry further comprises a radio frequency receiver.

48. A dialer apparatus as in claim 37 wherein said wireless transceiver circuitry stores said telephone dialing data received from the wireless mobile computing device for later retrieval.

49. A dialer apparatus as in claim 37 wherein said wireless transceiver circuitry further generating a wake-up signal whenever the telephone dialing data is received, and said processing circuitry operating in response to said wake-up signal, goes into a power-up mode and, after generating said telephone number signal corresponding to the stored telephone dialing data received from said wireless mobile computing device to the landline telephone system, goes into a power saving power-down mode of operation until once again receiving said wake-up signal.

50. A dialer apparatus for use with a telephone handset, connected to a wire landline telephone system, and a wireless mobile computing device having telephone numbers stored as data therein and capable of communicating data with outside devices using a wireless medium, said dialer apparatus useful for receiving data representative of a telephone number from the wireless mobile computing device and dialing the telephone number over the wire landline telephone system, said dialer apparatus comprising:
Wireless circuitry for receiving telephone dialing data from the wireless mobile computing device representative of a telephone number to be dialed over the landline telephone system; and,
Processing circuitry, connected to the landline telephone system, that upon receiving telephone dialing data from said wireless circuitry, generates a telephone number signal corresponding to the stored telephone dialing data received from said wireless mobile computing device to the landline telephone system.

51. A dialer apparatus as in claim 50 wherein said processing circuitry further comprises:
means for audibly signaling a user that the telephone dialing data from said wireless circuitry has been received.

52. A dialer apparatus as in claim 50 wherein said processing circuitry further comprises:
DTMF generating circuitry, connected to the landline telephone system, for receiving a telephone number signal and generating and sending landline telephone number dialing tones representative thereof on the landline telephone system.

53. A dialer apparatus as in claim 52 wherein said DTMF generating circuitry further generating an end of dialing signal upon completion of sending said landline telephone number dialing tones on the landline telephone system.

54. A dialer apparatus as in claim 50 wherein said processing circuitry further comprises:
pulse generating circuitry, connected to the landline telephone system, for receiving a telephone number signal and generating and sending landline telephone number dialing pulse signals representative thereof on the landline telephone system.

55. A dialer apparatus as in claim 54 wherein said pulse generating circuitry further generating an end of dialing signal upon completion of sending said landline telephone number dialing pulse signals on the landline telephone system.

56. A dialer apparatus as in claim 53 further comprising:
Line monitoring circuitry, responsive to said end of dialing signal, to alert a user that dialing is complete and to pick up the handset.

57. A dialer apparatus as in claim 50 wherein said processing circuitry only generates said off-hook signal if said telephone dialing data received from said wireless mobile computing device has the format of a valid landline telephone number.

58. A dialer apparatus as in claim 50 wherein said wireless circuitry further comprises an optical receiver.

59. A dialer apparatus as in claim 58 wherein said optical receiver comprises an Infrared receiver.

60. A dialer apparatus as in claim 50 wherein said wireless circuitry further comprises a radio frequency receiver.

61. A dialer apparatus as in claim 50 wherein said wireless transceiver circuitry stores said telephone dialing data received from the wireless mobile computing device for later retrieval.

62. A dialer apparatus as in claim 50 wherein said wireless transceiver circuitry further generating a wake-up signal whenever the telephone dialing data is received, and said processing circuitry operating in response to said wake-up signal, goes into a power-up mode and, after generating said telephone number signal corresponding to the stored telephone dialing data received from said wireless mobile computing device to the landline telephone system, goes into a power saving power-down mode of operation until once again receiving said wake-up signal.
